(19) United States
(12) Patent Application Publication
(10) Pub. No.: US 2024/0029109 A1
(43) Pub. Date: Jan. 25, 2024

(54) INFORMATION PROVIDING APPARATUS, INFORMATION PROVIDING SYSTEM, INFORMATION PROVIDING METHOD, AND NON-TRANSITORY COMPUTER READABLE MEDIUM

(71) Applicant: NEC Corporation, Minato-ku, Tokyo (JP)

(72) Inventors: Akira HASHIMOTO, Tokyo (JP); Kenichi ICHIHARA, Tokyo (JP); Toshikazu MARUYAMA, Tokyo (JP); Shizuko KANEGAE, Tokyo (JP)

(73) Assignee: NEC Corporation, Minato-ku, Tokyo (JP)

(21) Appl. No.: 18/025,287

(22) PCT Filed: Sep. 25, 2020
(86) PCT No.: PCT/JP2020/036249

§ 371 Date: Mar. 8, 2023

(51) Int. Cl. G06Q 30/0251; H04W 4/029; G06F 3/01

(52) U.S. Cl. CPC G06Q 30/0261; H04W 4/029; G06F 3/011

(57) ABSTRACT

To make it possible to appropriately provide content information to a user terminal by using position information of the user terminal. An information providing apparatus (10a, 10) includes a storage unit (102a) configured to store position information associated with a position on a map, content information associated with the position information, and an attribute corresponding to the content information, and a control unit (101a) configured to output first content information to a user terminal based on position information acquired from the user terminal, and then output second content information associated with an attribute of the first content information to the user terminal.

### TECHNICAL FIELD

The present disclosure relates to an information providing apparatus, an information providing system, an information providing method, and a program.

### BACKGROUND ART

In recent years, as communication apparatuses such as smartphones have become popular, services using position information called a geofence have started to be provided. The geofence is an area enclosed by a virtual fence (a virtual boundary line) provided (i.e., defined) on a map. By setting such a geofence, stores and the like in the geofence can provide information about the stores and the like, such as advertisements and coupons, to user terminals possessed by users who have entered the geofence.

For example, Patent Literature 1 discloses that a management server provides, in response to a supply from a mobile terminal apparatus, event information related to a facility to the mobile terminal apparatus.

### CITATION LIST

### Patent Literature

Patent Literature 1: International Patent Publication No. WO2016/194117

### SUMMARY OF INVENTION

### Technical Problem

In regard to technologies up to now, it, in some cases, is impossible to appropriately provide a content service to a user terminal.

The present disclosure has been made to solve the above-described problem, and an object thereof is to provide an information providing apparatus, an information providing system, an information providing method, a program and the like capable of appropriately providing content information to a user terminal by using position information of the user terminal.

### Solution to Problem

An information providing apparatus according to a first aspect of the present disclosure includes:
a storage unit configured to store position information associated with a position on a map, content information associated with the position information, and an attribute corresponding to the content information; and
a control unit configured to output first content information to a user terminal based on position information acquired from the user terminal, and then output second content information associated with an attribute of the first content information to the user terminal.

An information providing system according to a second aspect of the present disclosure is an information providing system including a user terminal and an information providing apparatus, in which
the information providing apparatus includes:
a storage unit configured to store position information associated with a position on a map, content information associated with the position information, and an attribute corresponding to the content information; and
a control unit configured to output first content information to the user terminal based on position information acquired from the user terminal, and then output second content information associated with an attribute of the first content information to the user terminal.

An information providing method according to a third aspect of the present disclosure including:
acquiring position information associated with a position on a map, content information associated with the position information, and an attribute corresponding to the content information; and
outputting first content information to a user terminal based on position information acquired from the user terminal, and then outputting second content information associated with an attribute of the first content information to the user terminal.

A non-transitory computer readable medium according to a fourth aspect of the present disclosure stores a program for causing a computer to:
acquire position information associated with a position on a map, content information associated with the position information, and an attribute corresponding to the content information; and
output first content information to a user terminal based on position information acquired from the user terminal, and then output second content information associated with an attribute of the first content information to the user terminal.

### Advantageous Effects of Invention

According to the present disclosure, it is possible to provide an information providing apparatus, an information providing system, an information providing method, a program and the like capable of appropriately providing content information to a user terminal by using position information of the user terminal.

### BRIEF DESCRIPTION OF DRAWINGS

FIG. 1 is a schematic diagram for explaining an overview of a content service according to some example embodiments;

FIG. 2 is a diagram for explaining an example of a configuration of an information providing apparatus according to a first example embodiment;

FIG. 3 is a flowchart showing an information providing method according to the first example embodiment;

FIG. 4 is a schematic diagram for explaining an overview of a content service according to some example embodiments;

FIG. 5 is a diagram for explaining an example of a configuration of an information providing apparatus according to a second example embodiment;

FIG. 6 is a flowchart showing an information providing method according to the second example embodiment;

FIG. 7 is a schematic diagram showing an overall configuration of an information providing system according to a third example embodiment;

FIG. 8 is a diagram for explaining an example of a configuration of a server according to the third example embodiment;

FIG. 9 is a block diagram showing an example of a configuration of the server according to the third example embodiment;

FIG. 10 shows an example of a hardware configuration of the server according to the third example embodiment;

FIG. 11 is a block diagram showing an example of a configuration of a hearable device according to the third example embodiment;

FIG. 12 is a block diagram showing an example of a configuration of a wearable device according to the third example embodiment;

FIG. 13 is a table for explaining an example of control of a content performed by the server according to the third example embodiment;

FIG. 14 is a schematic diagram for explaining an overview of control of an audio content service according to the third example embodiment; and

FIG. 15 is a flowchart showing a flow of control of an audio content.

### EXAMPLE EMBODIMENT

### First Example Embodiment

An example embodiment according to the present disclosure will be described hereinafter with reference to the drawings.

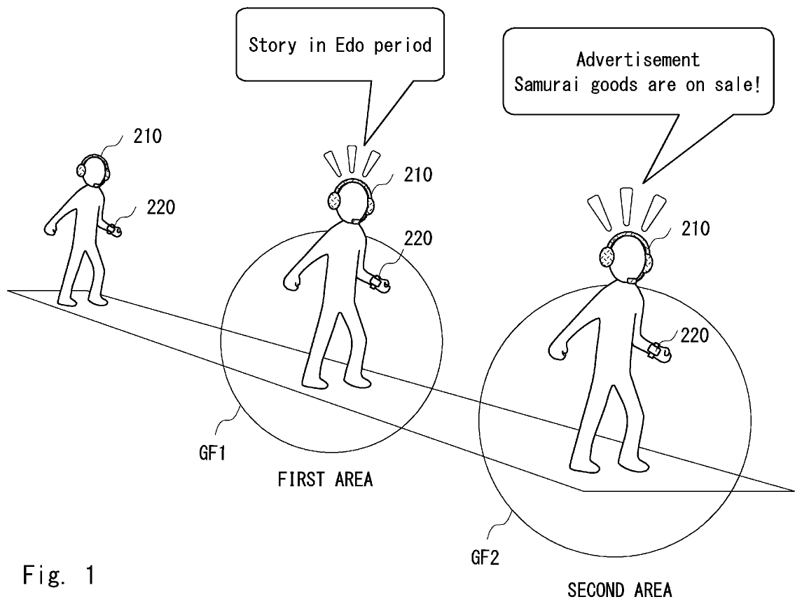

An outline of an information providing apparatus according to an example embodiment will be described with reference to FIG. 1.

Areas enclosed by virtual fences (virtual boundary lines) (also called geofences, and indicated as GF1 and GF2 in FIG. 1) are provided (i.e., defined) on a map. FIG. 1 shows a state in which a user is walking on a route toward a target object (not shown). As shown in FIG. 1, when a user, who possesses a user terminal such as a hearable device 210 or a wearable device 220, enters this first area GF1, a first content is provided from the information providing apparatus to the user terminal. This first content may be an audio content such as a sightseeing guide, or may be a content service in which visual AR (Augmented Reality) and an audio AR are fused (i.e., mixed), such as a content service in which a statue, a mascot doll, a signboard, and/or a poster in the street are personified and talk to users.

A geofence is usually provided (i.e., set) before a target object (i.e., between the current position of the user (e.g., a tourist) and the target object). The target object is not limited to buildings, facilities, and shops, but can also include various objects such as signs, signboards, mannequins, mascot dolls, animals, fireworks, and the like. A content provider in such a system may assume (e.g., predict) a route to the target object and can set (i.e., define) a geofence(s) on the assumed route. The route to the target object is a route along which pedestrians move (e.g., walk) to reach the target object, and is not limited to a route for which the estimated arrival time thereat is the shortest. That is, the route can include various routes along which pedestrians could move.

In this way, a content provider (including an advertiser) in such a system can, to some extent, predict the emotions of users who have viewed the first content and the direction in which they walk. Specifically, the content provider has analyzed the emotional states of users and a landscape at each point that the users will pass through during the time the content service is being provided in advance, so that it is possible to arouse strong willingness in the users to buy a product or the like by putting an advertisement(s) that matches the emotions of the users and the landscape at that point. The first content includes guide information for guiding users regarding the direction in which they should move, a route to the target object, a story associated with a building or scenery in or near the area the users are in, and the like.

In this example embodiment, the information providing apparatus also provides a second content associated with an attribute of the first content (or a second content having the same attribute as that of the first content) to the user terminal of the user, whose emotion or moving direction can be predicted as described above, or when such a user reaches the second area GF2. The second content can be mainly advertisement information having the same attribute as that of the first content, but is not limited to this example. The second content may be a content having the same attribute as that of the first content. The second content may be partially composed of advertisement information. The second content associated with the attribute of the first content does not necessarily have to have the same attribute as that of the first content. For example, the content provider (e.g., the advertiser) can associate the attribute of the second content with that of the first content in an arbitrary manner. For example, the advertiser can provide a second content having an attribute related to, from among the attributes of the first content, an attribute thereof with which an advertising effect can be expected. For example, when the first content is one for introducing, to a user, a castle in front of the user, the first content may be assigned attributes such as “history” and “majesty.”

In this case, examples of conceivable second contents associated with the first content include an advertisement for a whiskey “How about a glass of whiskey at the foot of the magnificent mountain range” or an advertisement for a period drama (“A historical drama concerning this castle will start next spring”). The second content may be an audio content or information such as an email or a message. The provider of the first content and the provider of the second content (e.g., the advertiser) may be the same as each other or different from each other. In this specification, the advertisement information means information about a product, a service, a company profile, or the like that the advertiser conveys to certain people in order to achieve an advertising goal. The attribute information is information indicating an attribute(s) of a content.

The first and second areas GF1 and GF2 may be mutually exclusive as shown in FIG. 1, or may partially overlap each other. That is, the second content can be provided while the first content is being provided, or after the first content is provided.

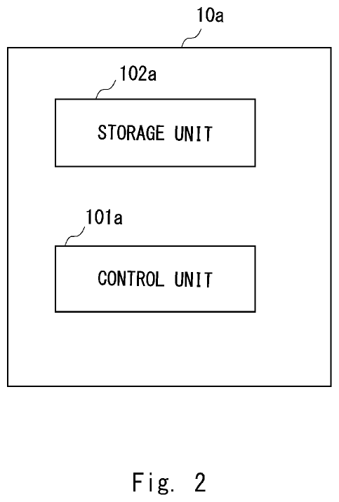

FIG. 2 is a diagram for explaining an example of a configuration of the information providing apparatus according to the first example embodiment.

The information providing apparatus 10a may be a server implemented by a computer. The information providing apparatus 10a includes a storage unit 102a that stores position information associated with a position on a map, content information associated with the position information, and an attribute(s) corresponding to the content information, and a control unit 101a that outputs first content information to a user terminal based on position information acquired from the user terminal, and then outputs second content information associated with an attribute of the first content information to the user terminal.

The second content information can contain an advertisement. The control unit 101a may output first content information to a user terminal based on position information acquired from the user terminal, and then output second content information having the same attribute as that of the first content information to the user terminal based on the position information acquired from the user terminal. In this case, the first content information includes delivery position information (including geofence information) of the first content and an attribute(s) of the first content. The second content information includes delivery position information of the second content different from the delivery position information of the first content, and an attribute(s) of the second content that is the same as or associated with that of the first content. The control unit 101a can store a user terminal ID and deliver an appropriate content to a specific user terminal.

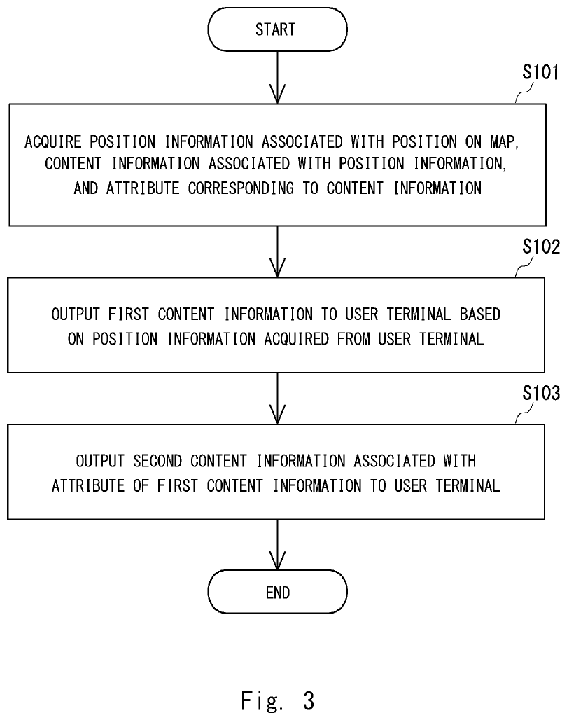

FIG. 3 is a flowchart showing an information providing method according to the first example embodiment.

Position information associated with a position on a map, content information associated with the position information, and an attribute(s) corresponding to the content information are acquired (Step S101). First content information is output to a user terminal based on position information acquired from the user terminal (Step S102). Second content information having the same attribute as that of the first content information is output to the user terminal (Step S103).

According to the above-described example embodiment, it is possible to appropriately provide content information to a user terminal by using position information of the user terminal. Further, it is possible to predict the emotion of a user and the direction in which the user will move by providing the content service, so that it is possible to provide an appropriate content to the user of which the emotion and the like have been predicted.

### Second Example Embodiment

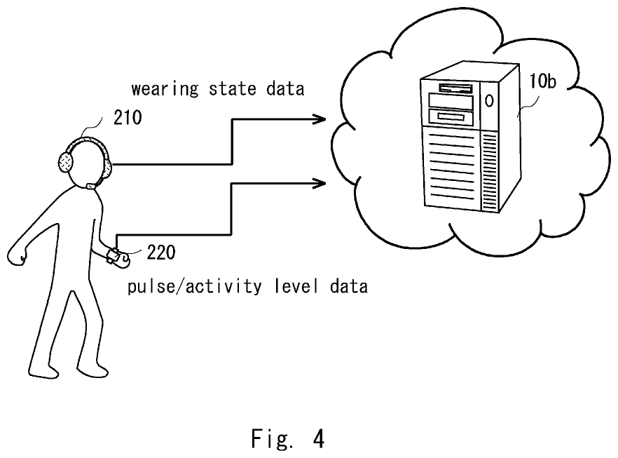

An outline of an information providing apparatus according to a second example embodiment will be described with reference to FIG. 4.

In this example embodiment, the emotion of a user, to which a first content has been provided, is analyzed based on biometric information of the user acquired from a user terminal (a wearable device 220 in this example), and a second content (a content following the first content) is provided more appropriately. Examples of the user terminal may include a wearable device, a hearable device, a smartwatch, and any combination thereof. The wearable device 220 is, for example, a smartwatch, and can acquire a pulse rate and an activity level of the user. Further, the hearable device 210 is, for example, a headset-type device, and can acquire the direction of the line of sight or the orientation of the face of the user. Such information is collected by a server (an information providing apparatus) 10, and the emotion of the user is analyzed there. As a result of the emotional analysis, the server controls the output of the second content based on interest information of the user for the first content (i.e., information about the interest the user has in the first content). Specifically, when the interest of the user in the first content is low, the server 10 can change the delivery position or the delivery time of the second content, or change the content information to second content information having an attribute different from that of the first content information. Further, the server may stop the output of the second content.

Note that although the server (the information providing apparatus) 10 acquires a pulse rate, an activity level, the direction of the line of sight, or the orientation of the face of a user, and analyzes the emotion of the user in the above-described example, the user terminal may analyze the emotion of the user based on the pulse rate, the activity level, the direction of the line of sight, or the orientation of the face of the user. In such a case, the server may acquire the interest information of the user for the first content from the user terminal and control the second content based on the interest information.

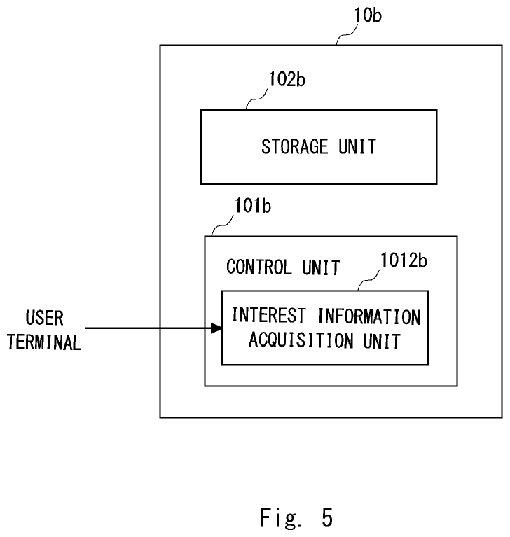

FIG. 5 is a diagram for explaining an example of a configuration of the information providing apparatus according to the second example embodiment.

The information providing apparatus 10b may be a server implemented by a computer. The information providing apparatus 10b includes a storage unit 102b that stores position information associated with a position on a map, content information associated with the position information, and an attribute(s) corresponding to the content information, and a control unit 101b that outputs first content information to a user terminal based on position information obtained from the user terminal, and then controls the output of a second content based on interest information for the first content obtained from user terminal that has acquired the first content information. The control unit 101b includes an interest information acquisition unit 1012b that acquires interest information from a user terminal, or acquires biometric information or line-of-sight information from a user terminal and analyzes interest information based on the biometric information or the line-of-sight information.

The user terminal is a portable terminal possessed by the user and can be, for example, a hearable device, a wearable device, or other suitable user devices.

The interest information of the user for the first content is determined based on biometric information of the user or posture information (i.e., information about the posture) (e.g., the line of sight or the orientation of the face) of the user acquired by the user terminal. The interest information is information including an interest score indicating a possibility that the user is interested in the content. The interest score is calculated based on, for example, parameters for identification learned in advance and feature values related to the biometric information of the user. Such identification parameters can be generated, for example, by performing machine learning by using feature values of biological information that is acquired when the user is having an interest and feature values of biological information that is acquired when the user is having no interest. The interest score means an indicator as to how much the user has interest as compared to the normal state (the uninterested state). The interest score can be expressed, for example, as a numerical value no smaller than zero and no larger than one. In this case, for example, the closer the interest score is to one, the higher the probability that the user has an interest is. Conversely, the closer the interest score is to zero, the higher the probability that the user has no interest is.

The interest information can include information indicating the type, degree, and presence/absence of the interest. Examples of the type of the interest include various emotions such as delight, anger, sorrow, pleasure, excitement, elation, accomplishment, and an excited feeling. The degree may be specified by a level (a numerical value) indicating the degree of strength for the type. The presence/absence of the interest can indicate whether or not the user is interested in the content depending on whether the interest score exceeds an arbitrarily determined threshold.

“Controlling the output of the second content” may include stopping the output of the second content, changing the second content (i.e., a change to a content having a different attribute), changing the delivery position of the second content, changing the delivery time, and the like. For example, when the interest of the user in the content is low, the output of the second content can be stopped. When the interest of the user in the content is low, the content can be changed to a content having a different attribute. Further, when the interest of the user in the content is low, the advertisement may be changed to an advertisement of which the duration is shorter than that of ordinary advertisements. “Controlling the output of the second content” may include various other suitable forms.

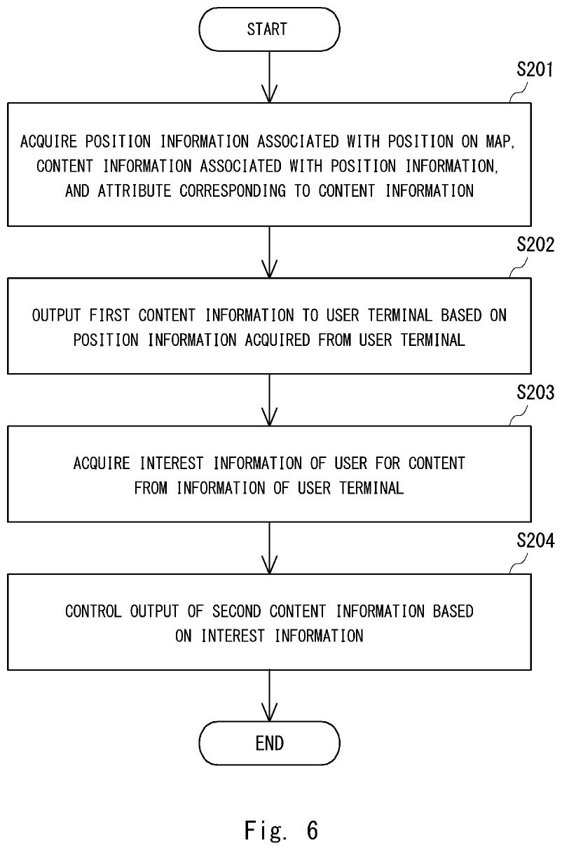

FIG. 6 is a flowchart showing an information providing method according to the second example embodiment.

Position information associated with a position on a map, content information associated with the position information, and an attribute(s) corresponding to the content information are acquired (Step S201). First content information is output to a user terminal based on position information acquired from the user terminal (Step S202). Interest information of the user for the content is acquired from information of the user terminal information (Step S203). The output of second content information is controlled based on the interest information (Step S204).

In the above-described example embodiment, by analyzing the emotion of a user to which a content has been provided, it is possible to recognize the interest of the user in the content, and thereby appropriately control the output of the subsequent content based on the interest information.

### Third Example Embodiment

An outline of an audio content service according to a third example embodiment will be described.

In this example, it is assumed that a user walks around a town, an event space, or the like while wearing a user terminal such as a hearable device or a wearable device. At least one geofence is disposed (i.e., defined) at a predetermined place. When the user enters the geofence, various audio contents (e.g., a sightseeing guide) are played back through the user terminal. In this example embodiment, a system that plays back an audio content for a user present in a specific area by using a highly-accurate geofence and an acoustic localization technology is used. The system may also be called an SSMR (Space Sound Mixed Reality) service. Such an audio content may be a guide service (also called a content service) in which “visual AR” and “acoustic AR” are fused (i.e., mixed). In such an SSMR system, an audio advertisement spot is provided to an advertiser. The advertiser can deliver (or distribute) its own audio advertisement that fits the audio content service in such an SSMR system.

From the past, advertisement spots have been provided on moving image distribution platforms and other various platforms such as television and radio. For example, advertisements are provided between programs (contents) in television and radio. However, with conventional advertisement spots, advertises have not been able to satisfactorily approach viewers/listeners of contents. In particular, they have not been able to satisfactorily approach the emotional sides of users that are affected by the development of the content. Therefore, the present disclosure provides a system that efficiently provides an advertisement according to the emotion or the degree of interest of a user.

Specifically, in the SSMR system, it is possible to predict, to some extent, the emotion of the user and the direction in which the user will walk based on the scenario of the content. Further, the emotional state of a user and a landscape at each point that the user will visit during a content service have been determined (e.g., predicted) in advance, so that it is possible to arouse strong willingness to buy a product or the like by putting an advertisement that match the emotion and the landscape at that point. In this system, it is possible to define a new advertisement spot different from conventional advertisement spots. Further, the use of MEC (Multi-access Edge Computing) makes it easier to switch the content of the SSMR service, and an audio advertisement that fits the weather of the day, the time period, and the attribute of the user (e.g., a gender and an age group) is delivered. In this way, it becomes possible to realize a mechanism to arouse willingness to buy a product or the like even further. Further, in the present disclosure, as shown in FIG. 4, the delivery of an advertisement is controlled based on the interest information for the content acquired from the user wearing a hearable device, a wearable device, or the like. As the interest information, the line of sight and the posture of the user can be detected by using a nine-axis sensor provided inside the hearable device. Further, as the interest information, data such as a pulse rate and an activity level can be acquired by using the wearable device. The server collects the interest information of the user and makes it possible to deliver an appropriate advertisement based on the interest information.

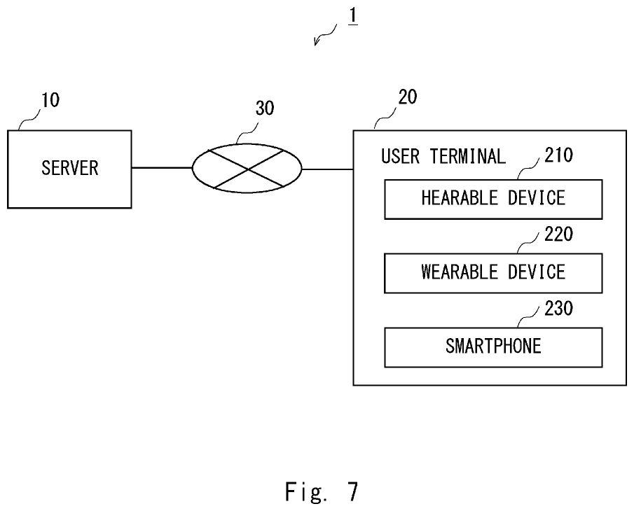

FIG. 7 is a diagram for explaining an overall configuration of an information providing system.

An information providing system 1 includes a server 10 (also called an information providing apparatus) and a user terminal 20 connected to the server through a wired or wireless network 30. The network 30 may include a local area network (LAN) and a wide area network (WAN), for example, the Internet or a mobile communication network. The server 10 is an example of the information providing apparatus according to the first or second example embodiment. The user terminal 20 may include a hearable device 210, a wearable device 220, and a smartphone 230. The user terminal 20 is not limited to these devices and may be a part of these devices (e.g., is composed of a hearable device or a wearable device alone). Alternatively, other suitable devices may be used.

The server 10 provides, for example, information about a specific target object on a map, a facility, a store, and the like (e.g., information about an event or the like), and/or a guide service (a content service) in which “visual AR” and “acoustic AR” are fused to a user terminal possessed by a user who has entered the geofence. These target object and the like are associated with the geofence which has been set (e.g., defined) in advance. In this specification, the geofence may also be simply called as an area.

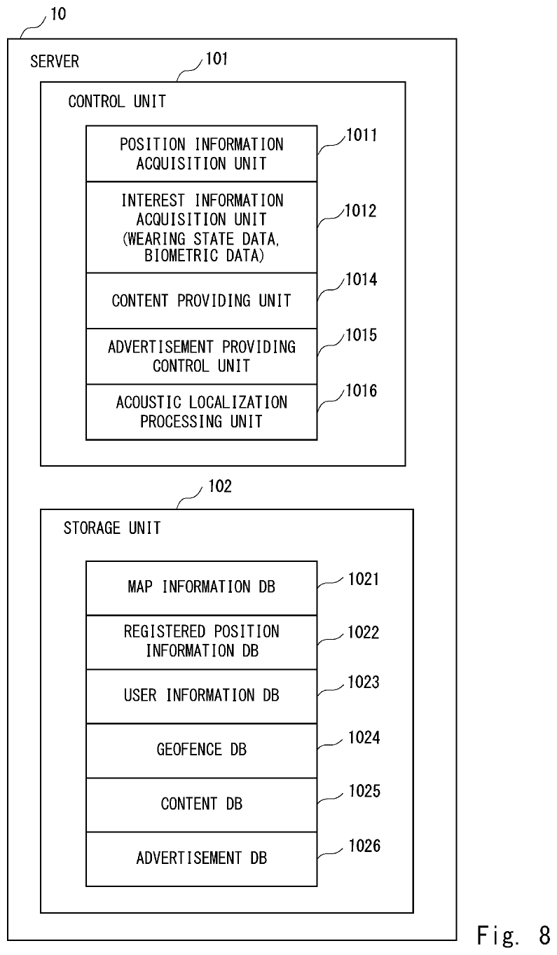

FIG. 8 shows an example of a configuration of a server.

The server 10 is a computer including a control unit 101 and a storage unit 102. The control unit 101 includes a processor such as a CPU (Central Processing Unit). The control unit 101 includes a position information acquisition unit 1011, an interest information acquisition unit 1012, a content providing unit 1014, an advertisement provision control unit 1015, and an acoustic localization processing unit 1016. Note that the server 10 may be disposed on a cloud side through a mobile network and the Internet, or on a base-station side through a mobile network such as 5G using MEC (Multi-access Edge Computing).

The position information acquisition unit 1011 acquires position information of a user terminal through the network. The interest information acquisition unit 1012 acquires interest information of a user for a content. The interest information acquisition unit 1012 may acquire interest information of a user for a content by acquiring biometric information and posture information (the direction of the line of sight or the orientation of the face) of the user from the user terminal 20 and analyzing the emotion of the user based thereon.

The content providing unit 1014 delivers (or distributes) a content to the user terminal 20 through the network. The content providing unit 1014 can appropriately deliver the content based on a content ID and a user terminal ID. The content may be an audio content, or may be a combination of an audio content and a visual content.

The advertisement provision control unit 1015 delivers (or distributes) an advertisement to the user terminal 20 through the network. Further, the advertisement provision control unit 1015 can also control how to provide an advertisement to the user terminal 20 based on the interest information of the user. Based on the interest information, the advertisement provision control unit 1015 can deliver an advertisement having the same attribute as that of the content as described above or an attribute different from that of the content. Further, the advertisement provision control unit 1015 may also change a delivery position or a delivery time based on the interest information.

The acoustic localization processing unit 1016 performs sound-image localization processing on the audio content to be output according to the position of the target object and the posture information of the user (i.e., the orientation of the user terminal). The sound-image localization processing performed in the acoustic AR is to generate, as right-ear sound information and left-ear sound information, two pieces of sound information of which sound images are localized at the position of the virtual sound source. As the user listens to these (two pieces of) audio information, he/she can experience a virtual emotion as is he/she is listening the sound from the position of the virtual sound source. In the sound-image localization, the distance from the virtual sound source and the direction to the user with respect to the virtual sound source are acquired, and sound-image localization processing is performed for the sound content based on the acquired information. The distance between the virtual sound source and the user can be calculated based on the latitude/longitude information of the position of the virtual sound source and that of the position of the user. The direction to the user with respect to the virtual sound source can be calculated based on the movement angle and the position information of the virtual sound source. The position of the virtual sound source may be the same as the target-object position information indicating the position of the target object. Further, in the case where the user experiences the sensation of hearing a speech from the target object located near him/her or a speech from a virtual girlfriend/boyfriend, the position of the virtual sound source may be a position corresponding to an object or a virtual object provided near the user. In this way, the user can hear audio information, of which the sound image has been localized, according to the orientation of the head of the user when the user enters the geofence. Therefore, even when the angle at which the user enters the geofence varies within a range of the angle-of-entry threshold, the user can hear the sound as the audio information from the predetermined position.

The storage unit 102 includes a map information database 1021, a registered position information database 1022, a user information database 1023, a geofence database 1024, a content database 1025, and an advertisement database 1026.

The map information database 1021 may contain information about a road network including roadways, sidewalks and the like, junctions including intersections, T-intersections, and the like, traffic signals, traffic signs, various buildings, various facilities, and the like.

The registered position information database 1022 stores (i.e., contains), for example, information about registered target objects such as shops, buildings, museums, cinemas, archaeological sites, and sightseeing spots. Further, the registered position information database 1022 can store (i.e., contain) position information of various objects such as signs, signboards, mannequins, mascot dolls, animals, fireworks, and the like. By having a staff of a facility register such information in the information providing system 1 in advance, such information can be provided to the user terminal 20 of a user who has entered the geofence associated with the facility. Content data in which information related to the registered position information is fused with visual AR and/or acoustic AR may be provided to the user terminal 20.

The user information database 1023 may include information about users (user identification information) who want to receive content information through their user terminals 20, such as user IDs, passwords, terminal IDs, ages, genders, hobbies, and preferences of users. Further, the user information database 1023 can include information about target objects such as various objects including stores from which users want to receive information, buildings, museums, cinemas, archaeological sites, sightseeing spots, signs, signboards, mannequins, mascot dolls, animals, fireworks, and the like. The user ID is an identifier by which the user is uniquely identified. The terminal ID is an identifier by which the terminal is uniquely identified.

The geofence database 1024 can include, in association with the above-described registered position information, the geofence ID, latitude, longitude, range, size, angle-of-entry threshold, and angle-of-exit threshold of the set geofence. The geofence ID is an identifier by which the geofence is uniquely identified. The geofence can include an area(s) for a content and an area(s) for delivering an advertisement.

The content database 1025 may include content information associated with the geofence ID for the content and the user ID. The content information may be a content including acoustic AR having a predetermined play-back time, or content data having a predetermined play-back time in which visual AR and acoustic AR are fused. The length, i.e., the predetermined play-back time, of such a content can be arbitrarily set while taking the walking speed of the user, the distance between the geofence and the store, and the like into consideration.

Further, the advertisement database 1026 stores (i.e., contains) various types of advertisements associated with the geofence ID for advertisement delivery and the user ID and associated with the attributes of the respective contents (also called as audio contents corresponding to specific attributes), and their advertisements ID. The advertisement ID is an identifier by which the advertisement is uniquely identified. Further, the advertisement database 1026 stores (i.e., contains) various types of advertisements associated with the geofence ID for advertisement delivery and the user ID but not associated with the attributes of the respective contents (also called as audio contents not corresponding to specific attributes), and their advertisements ID. The advertisement database 1026 can also store (i.e., contain) a plurality of advertisements (i.e., audio contents corresponding to specific attributes and audio contents not corresponding to specific attributes) for one content.

Note that although the storage unit 102 is disposed inside the server 10 in the above-described example, the storage unit 102 may be disposed outside the server 10. In that case, when the storage unit 102 is disposed inside the information providing system, the present disclosure can be carried out by a server that is connected to the storage unit disposed outside the server 10 through a network.

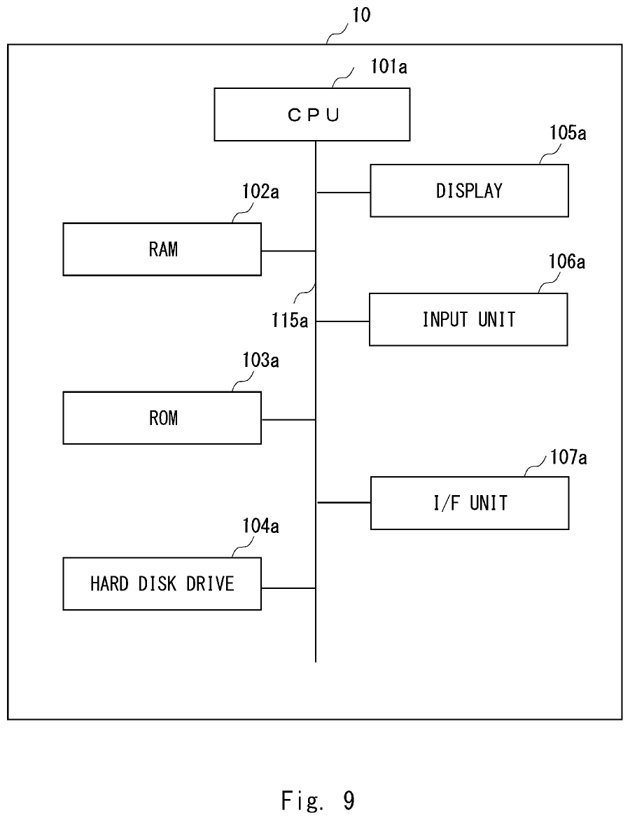

FIG. 9 is a block diagram showing an example of a hardware configuration of the server 10 in this example embodiment. As shown in FIG. 7, the server 10 is a computer (an information processor) including a CPU 101a, a RAM 102a, a ROM 103a, and the like. The CPU 101a performs calculation and control according to software stored in the RAM 102a or the ROM 103a, or in a hard disk drive 104a. The RAM 102a is used as a temporary storage area when the CPU 101a performs various processes. In the hard disk drive 104a, an operating system (OS), a registration program, and the like are stored. A display 105a is composed of a liquid-crystal display and a graphic controller, and objects such as images and icons, and GUIs are displayed on the display 105a. An input unit 106a is a device by which a user gives various instructions to the server 10, and composed of, for example, buttons, a keyboard, an on-screen keyboard, a mouse, and the like. An I/F (InterFace) unit 107a can control wireless or wired LAN communication in conformity with IEEE 802.11a or the like, and communicate with external apparatuses through the same communication network or the Internet in accordance with a protocol such as TCP/IP. A system bus 115a controls transmission/reception of data to/from the CPU 101a, the RAM 102a, the ROM 103a, and the hard disk drive 104a.

The user terminal 20 can be, for example, a computer that a user walking on the street can carry, such as a smartphone, a wearable device, a smartphone watch, or a hearable device.

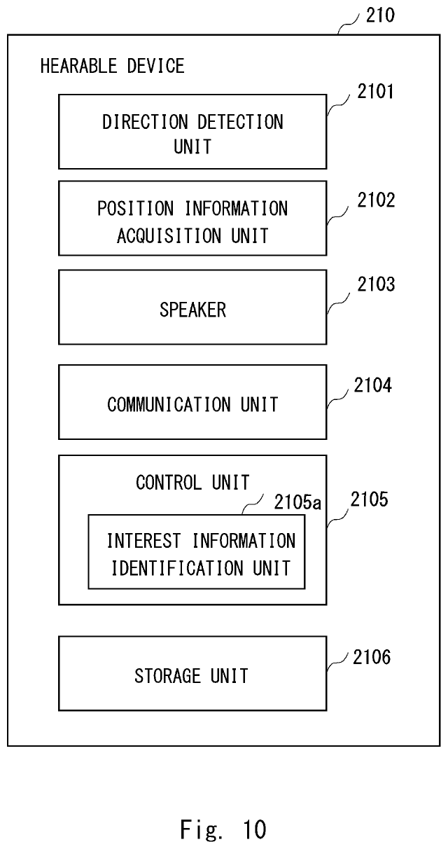

FIG. 10 is a block diagram showing a configuration of a hearable device.

The hearable device 210 can be a headset by which a user listens to an audio content provided from the server. The hearable device 210 can detect the direction of the line of sight of the user wearing it in order to achieve a highly-precise acoustic localization technology. The hearable device may be a type of device that covers both ears of a user, or a bone-conducting type that does not cover both ears of a user.

The hearable device 210 includes a direction detection unit 2101, a position information acquisition unit 2102, a speaker 2103, a communication unit 2104, a control unit 2105, and a storage unit 2106. Further, the hearable device 210 may include a microphone that collects voices of a user and/or ambient sounds (not shown).

The direction detection unit 2101 includes a nine-axis sensor(s) including a three-axis accelerometer, a three-axis gyroscopic sensor, a three-axis compass sensor, and the like for acquiring the direction of the hearable device (i.e., the orientation of the face or the direction of the line of sight of the user). In this way, it is possible to accurately acquire the orientation of the face or the direction of the line of sight of the user.

The position information acquisition unit 2102 includes a GPS (Global Positioning System) receiver, which can detect the current position of the hearable device on the earth and the current time by receiving radio waves transmitted from satellites. Note that position information acquisition unit does not have to be disposed inside the hearable device 210. In that case, a position information acquisition unit 2302 of the smartphone (which will be described later) can be used.

The speaker 2103 can play back an audio content provided from the server and enables a user to listen to the audio content.

The communication unit 2104 is a communication interface with the network 30. The communication unit 2104 is used to communicate with other network node apparatuses included in the information providing system. The communication unit 2104 may be used to perform radio communication. For example, the communication unit 2104 may be used to perform wireless LAN communication specified in IEEE 802.11 series, or mobile communication specified in 3GPP (3rd Generation Partnership Project) or the like. Further, the communication unit 2104 can also connect to a smartphone or a wearable device through Bluetooth (Registered Trademark) or the like so that they can communicate with each other. The communication unit 2104 can transmit line-of-sight information to the server 10.

The control unit 2105 is composed of a processor, a memory, and the like, and performs various processes of the hearable device by loading software (a computer program) from the storage unit 2106 onto a memory and executing the loaded software. Further, the control unit 2105 controls hardware included in the hearable device 210. The processor may be, for example, a microprocessor, an MPU (Micro Processing Unit), or a CPU (Central Processing Unit). The processor may include a plurality of processors.

The control unit 2105 includes an interest information identification unit 2105a that identifies interest information for an audio content provided from the server based on the orientation of the face, the direction of the line of sight, or the like of the user acquired by the direction detection unit 2102. For example, when the face of the user is facing downward, an interest information identification unit 2105a can determine that the user is less interested in the audio content. Alternatively, in the case where the sound image is localized for the target object as if the target object speaks to the user as described above, it is possible to determine that the user is less interested in the audio content when the user is facing in a direction different from the direction toward the target object.

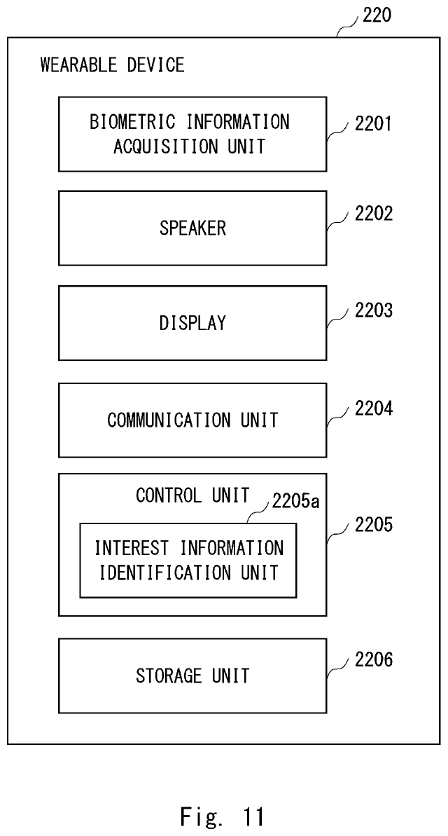

FIG. 11 is a block diagram showing a configuration of a wearable device.

The wearable device 220 may be, for example, but not limited to, a smartwatch. That is, the wearable device 220 may be any of various other types of wearable devices that can be used to acquire biometric information, such as a pulse rate and an activity level, of the user in real time.

The wearable device 220 includes a biometric information acquisition unit 2201, a speaker 2202, a display 2203, a communication unit 2204, a control unit 2205, and a storage unit 2206. The control unit 2205 can include an interest information identification unit 2205a.

The biometric information acquisition unit 2201 can acquire biometric information of a user who is wearing the wearable device 220. The biometric information means information about a living body that can be measured by a sensor or the like. Specifically, examples of the biometric information include, but are not limited to, a heart rate (a pulse rate), respiration, a blood pressure, a core temperature, a consciousness level, a skin temperature, a skin conductance response (Galvanic Skin Response (GSR)), a skin potential, a myoelectric potential, an electrocardiogram waveform, an electroencephalogram waveform, an amount of sweat, a blood oxygen saturation level, a pulse waveform, optical brain function mapping (Near-infrared Spectroscopy (NIRS)), and a pupil reflection.

The biometric information acquisition unit 2201 may include a speaker 2202 for alerting a user by a sound (or a voice) and a display 2203 for displaying a content to the user.

The communication unit 2204 is a communication interface with the network 30. The communication unit 2204 is used to communicate with other network node apparatuses included in the information providing system. The communication unit 2204 may be used to perform radio communication. For example, the communication unit 2204 may be used to perform wireless LAN communication specified in IEEE 802.11 series, or mobile communication specified in 3GPP (3rd Generation Partnership Project) or the like. Further, the communication unit 2204 can also connect to a smartphone or a hearable device through Bluetooth (Registered Trademark) or the like so that they can communicate with each other. The communication unit 2204 can transmit biometric information to the server 10.

The control unit 2205 is composed of a processor, a memory, and the like, and performs various processes of the hearable device by loading software (a computer program) from the storage unit 2206 onto a memory and executing the loaded software. Further, the control unit 2205 controls hardware included in the hearable device 210. The processor may be, for example, a microprocessor, an MPU (Micro Processing Unit), or a CPU (Central Processing Unit). The processor may include a plurality of processors.

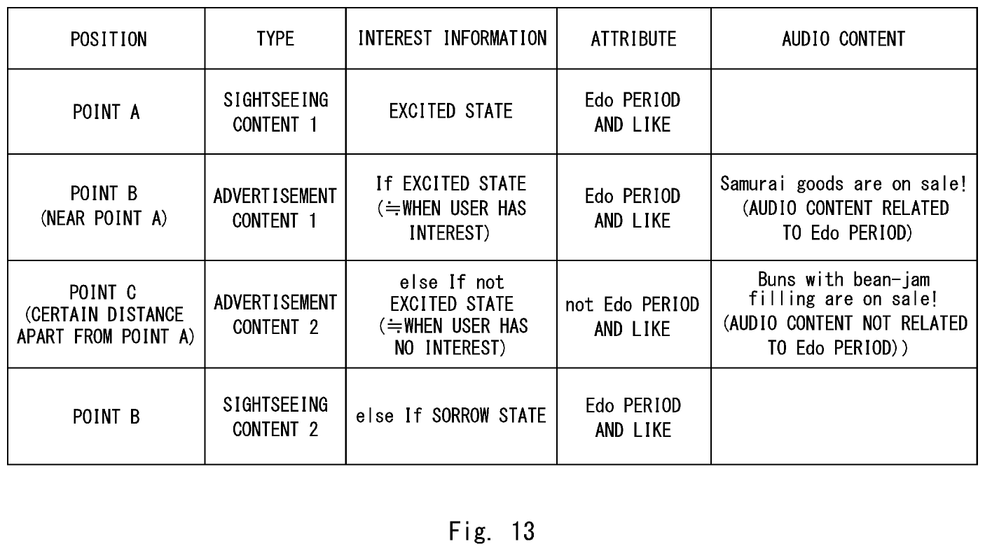

The control unit 2205 includes the interest information identification unit 2205a that identifies interest information for an audio content provided from the server based on acquired biometric information. The interest information will be described later with reference to FIG. 13.

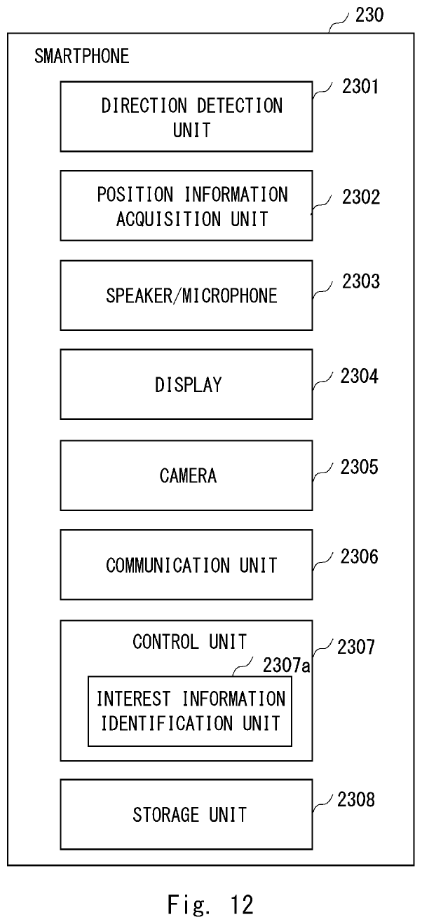

FIG. 12 is a block diagram showing a configuration of s smartphone.

The smartphone 230 can be used to view and listen to an audio content and a visual content provided from the server. Further, the smartphone 230 can be used to detect the orientation of the user and acquire the position of the user. Further, the smartphone 230 may also be configured so as to acquire the direction of the line of sight of the user from the hearable device 210 and thereby identify interest information. Further, the smartphone 230 may be configured so as to acquire biometric information from the wearable device and thereby identify interest information.

The smartphone 230 includes a direction detection unit 2301, a position information acquisition unit 2302, a speaker/microphone 2303, a display 2304, a camera 2305, a communication unit 2306, a control unit 2307, and a storage unit 2308. The control unit 2307 may include an interest information identification unit 2307a.

The direction detection unit 2301 includes a nine-axis sensor(s) including a three-axis accelerometer, a three-axis gyroscopic sensor, a three-axis compass sensor, and the like for acquiring the direction of the smartphone (i.e., the orientation of the user).

The position information acquisition unit 2302 includes a GPS (Global Positioning System) receiver, which can detect the current position of the smartphone on the earth and the current time by receiving radio waves transmitted from satellites. Note that position information acquisition unit does not have to be disposed inside the smartphone 0. In that case, the above-described position information acquisition unit 2102 of the hearable device can be used.

The speaker/microphone 2303 may be used by the user to make a phone call (i.e., to talk on the phone). Further, the speaker can be used by the user to listen to the audio content provided from the server.

The display 2304 is composed of a liquid-crystal display and a graphic controller. The display 2304 can display objects such as images and icons, and GUIs. The display 2304 may display a visual content provided from the server.

The camera 2305 includes an image-pickup device such as a CMOS sensor, and can be used to take external video images or still images.

The communication unit 2306 is a communication interface with the network 30. The communication unit 2306 is used to communicate with other network node apparatuses included in the information providing system. The communication unit 2306 may be used to perform radio communication. For example, the communication unit 2306 may be used to perform wireless LAN communication specified in IEEE 802.11 series, or mobile communication specified in 3GPP (3rd Generation Partnership Project) or the like. Further, the communication unit 2306 can also connect to a wearable device or a hearable device through Bluetooth (Registered Trademark) or the like so that they can communicate with each other. The communication unit 2306 can transmit user information (biometric information and line-of-sight information) acquired from the wearable device or the hearable device to the server.

The control unit 2307 is composed of a processor, a memory, and the like, and performs various processes of the smartphone by loading software (a computer program) from the storage unit 2308 onto a memory and executing the loaded software. Further, the control unit 2307 controls hardware included in the smartphone 230. The processor may be, for example, a microprocessor, an MPU (Micro Processing Unit), or a CPU (Central Processing Unit). The processor may include a plurality of processors.

The control unit 2307 may include the interest information identification unit 2307a that identifies interest information for an audio content provided from the server based on biometric information acquired from a wearable device (which is connected to the smartphone so that they can communicate with each other). Further, the interest information identification unit 2307a can identify interest information of a user for an audio content based on the orientation of the user acquired from the direction detection unit 2301.

Note that although a case where the wearable device is used as the biometric information acquisition unit is explained in the above-described example, the present disclosure is not limited to this example. The biometric information acquisition unit may be, for example, a contact-type sensor such as a wristwatch-type sensor (e.g., a smartwatch), or a non-contact-type sensor such as an infrared-type sensor, a radio-wave-type sensor, or a camera that photographs the user.

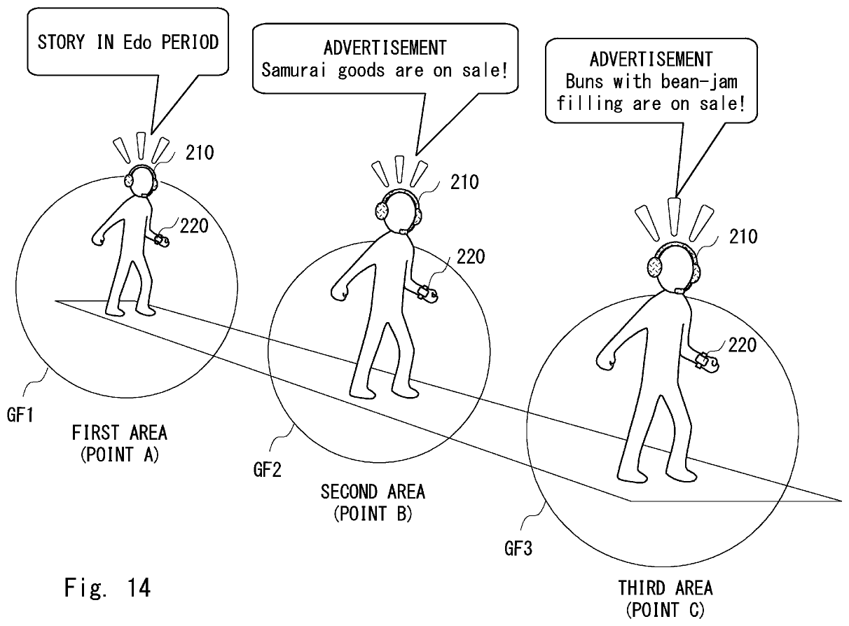

An example of control of a content performed by the server will be described hereinafter with reference to FIGS. 13 and 14.

In a table shown in FIG. 13, a type of content, interest information, an attribute, and details of an audio content are shown for each position. FIG. 14 is a schematic diagram for explaining an outline of control of an audio content service according to the third example embodiment. It is assumed that a route that extends through points A, B and C in this order is defined. When a user reaches the point A, a content for a sightseeing guide of which the attribute is an Edo period is delivered (or distributed) to a user terminal (the hearable device 210 in FIG. 13). It is determined that the user, who has listened to this content, is in an excited state based on biometric information and posture information of the user acquired through the user terminal (the wearable device 220 in FIG. 13).

Next, when the excited state of the user continues (i.e., the user remains in the interested state) at the point B near the point A, an advertisement content having the same attribute (the Edo period in this example) is delivered to the user. For example, an audio content “Samurai goods are on sale!” is delivered as the advertisement content. Note that although the content for a sightseeing guide and the advertisement content have the same attribute in this example, the present disclosure is not limited to this example. For example, when the attribute of the first content is the Edo period, attributes “period”, “old time”, “samurai”, and the like are included in a group of attributes associated with the attribute of the first content. These relevant attributes may be grouped in advance. A first attribute added to the first content information and an attribute group associated with the second content information may be stored in a table or the like in advance.

Further, when the excited state of the user is subsided (i.e., the user is no longer in the interested state) at the point C, an advertisement content 2 having a different attribute is delivered. For example, an audio content “Buns with bean-jam filling are on sale!” is delivered as another advertisement content.

Alternatively, when the user is in a sorrow state at the point B, a different content (e.g., another content for a sightseeing guide) may be delivered.

Although the user has enjoyed the content service by using the hearable device in this example, it is not limited to this example. For example, a smartphone may be used in place of the hearable device. Further, although different content services are controlled in three areas (at three points) in this example, various content services can be controlled in four or more areas.

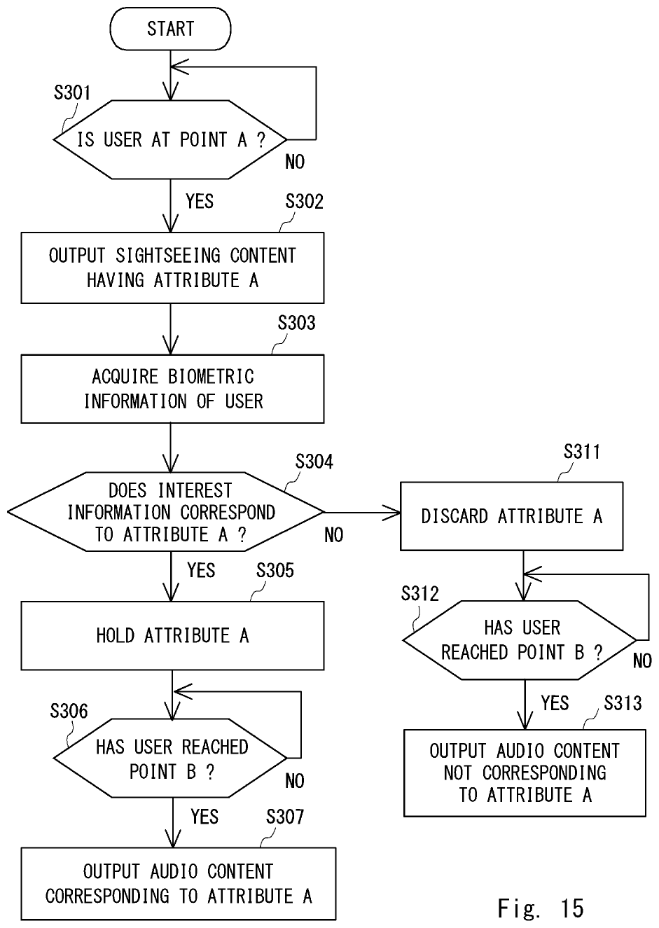

A flow of control of an audio content will be described with reference to FIG. 15.

When the server 10 detects that there is a user terminal 20 at the point A (Yes at Step S301), the server 10 outputs a sightseeing content having an attribute A to the user terminal 20 (Step S302). After that, the server 10 acquires biometric information (and posture information) of the user through user terminal 20 (Step S303). The server 20 analyzes interest information for the content based on the biometric information (and the posture information) of the user.

When the interest information of the user corresponds to the attribute A (Yes at Step S304), the server holds (i.e., retains) the attribute A (Step S305). When the server 10 detects that the user, who possesses the user terminal 20, reaches the point B (Yes at Step S306), the server 10 outputs an audio content corresponding to the attribute A (Step S307).

On the other hand, when the interest information does not correspond to the attribute A (No at Step S304), the server discards the attribute A (Step S311). When the server 10 detects that the user, who possesses the user terminal 20, reaches the point B (Yes at Step S312), the server 10 outputs an audio content that does not correspond to the attribute A (Step S313).

According to the above-described example embodiment, it is possible to analyze the interest of the user in the content based on the biometric information of the user, and thereby to appropriately control the subsequent content based on the analysis.

### Other Example Embodiment

As a modified example of the above-described example embodiment, the present disclosure can also be applied to an advertising fee billing system. When the same advertisement information is provided as the second content to a large number of user terminals (e.g., a large number of hearable devices), the server may calculate the amount of money obtained by multiplying the number of users each of which is properly wearing a user terminal (e.g., a hearable device) by a unit price of the advertisement as an advertising fee. Further, users who are less interested in the content may be excluded from the number of users properly wearing user terminals. In this way, a platform company that manages the server can charge an advertiser(s) an appropriately-calculated advertising fee.

Further, as a modified example of the above-described example embodiment, the present disclosure can also be applied to an advertisement verification system. When advertisement information is provided as a second content to a specific user terminal, the server can also acquire biometric information from this user terminal and analyze the emotion of the user after providing the advertisement information. For example, when the user is frustrated with the advertisement, a platform company managing the server can feed back such a verification result to an advertiser. The advertiser can appropriately modify the advertisement based on such feedback.

In the above-described example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, DVD (Digital Versatile Disc), BD (Blu-ray (Registered Trademark) Disc), and semiconductor memories (such as mask ROM, PROM (Programmable ROM), EPROM (Erasable PROM), flash ROM, and RAM (Random Access Memory)). Further, the program may be provided to a computer using any type of transitory computer readable media. Examples of transitory computer readable media include electric signals, optical signals, and electromagnetic waves. Transitory computer readable media can provide the program to a computer through a wired communication line (e.g., electric wires, and optical fibers) or a wireless communication line.

Note that the present disclosure is not limited to the above-described example embodiments, and they may be modified as appropriate without departing from the scope and spirit of the disclosure. For example, the user terminal may have some or all of the functions of the server 10. A plurality of examples described above can also be carried out while combining them with one another.

The whole or part of the example embodiments disclosed above can be described as, but not limited to, the following supplementary notes.

### (Supplementary Note 1)

An information providing apparatus comprising:
a storage unit configured to store position information associated with a position on a map, content information associated with the position information, and an attribute corresponding to the content information; and
a control unit configured to output first content information to a user terminal based on position information acquired from the user terminal, and then output second content information associated with an attribute of the first content information to the user terminal.

### (Supplementary Note 2)

The information providing apparatus described in Supplementary note 1, wherein the first content information includes guide information and the second content information includes advertisement information.

### (Supplementary Note 3)

The information providing apparatus described in Supplementary note 1, wherein the control unit outputs the first content information to the user terminal based on the position information acquired from the user terminal, and then outputs the second content information associated with the attribute of the first content information to the user terminal based on the position information acquired from the user terminal.

### (Supplementary Note 4)

The information providing apparatus described in Supplementary note 1, wherein the control unit controls the output of the second content based on interest information for the first content obtained from information of the user terminal that has acquired the first content information.

### (Supplementary Note 5)

The information providing apparatus described in Supplementary note 3, wherein the control unit changes a delivery position or a delivery time of the second content based on interest information for the first content obtained from the user terminal that has acquired the first content information.

### (Supplementary Note 6)

The information providing apparatus described in Supplementary note 3, wherein the control unit changes content information to second content information having an attribute different from that of the first content information based on interest information for the first content obtained from the user terminal that has acquired the first content information.

### (Supplementary Note 7)

The information providing apparatus described in any one of Supplementary notes 4 to 6, wherein the interest information is determined based on biometric information of a user obtained from the user terminal.

### (Supplementary Note 8)

The information providing apparatus described in any one of Supplementary notes 4 to 7, wherein the interest information is determined based on posture information of a user obtained from the user terminal.

### (Supplementary Note 9)

An information providing system comprising a user terminal and an information providing apparatus, wherein
the information providing apparatus includes:
a storage unit configured to store position information associated with a position on a map, content information associated with the position information, and an attribute corresponding to the content information; and
a control unit configured to output first content information to the user terminal based on position information acquired from the user terminal, and then output second content information associated with an attribute of the first content information to the user terminal.

### (Supplementary Note 10)

The information providing system described in Supplementary note 9, wherein the first content information includes guide information and the second content includes advertisement information.

### (Supplementary Note 11)

The information providing system described in Supplementary note 9, wherein the control unit outputs the first content information to the user terminal based on the position information acquired from the user terminal, and then outputs the second content information associated with the attribute of the first content information to the user terminal based on the position information acquired from the user terminal.

### (Supplementary Note 12)

The information providing system described in Supplementary note 9, wherein the control unit controls the output of the second content based on interest information for the first content obtained from information of the user terminal that has acquired the first content information.

### (Supplementary Note 13)

The information providing system described in Supplementary note 12, wherein the control unit changes a delivery position or a delivery time of the second content based on interest information for the first content obtained from the user terminal that has acquired the first content information.

### (Supplementary Note 14)

The information providing system described in Supplementary note 12, wherein the control unit changes content information to second content information having an attribute different from that of the first content information based on interest information for the first content obtained from the user terminal that has acquired the first content information.

### (Supplementary Note 15)

The information providing system described in any one of Supplementary notes 12 to 14, wherein the user terminal comprises a wearable device, and the interest information is determined based on biometric information of a user obtained from the wearable device

### (Supplementary Note 16)

The information providing system described in any one of Supplementary notes 12 to 15, wherein the user terminal comprises a hearable device, and the interest information is determined based on posture information of a user obtained from the hearable device

### (Supplementary Note 17)

An information providing method comprising:
acquiring position information associated with a position on a map, content information associated with the position information, and an attribute corresponding to the content information; and
outputting first content information to a user terminal based on position information acquired from the user terminal, and then outputting second content information associated with an attribute of the first content information to the user terminal.

### (Supplementary Note 18)

The information providing method described in Supplementary note 17, wherein the first content information includes guide information and the second content includes advertisement information.

### (Supplementary Note 19)

The information providing method described in Supplementary note 17, wherein the first content information is output to the user terminal based on the position information acquired from the user terminal, and then the second content information associated with the attribute of the first content information is output to the user terminal based on the position information acquired from the user terminal.

### (Supplementary Note 20)

The information providing method described in Supplementary note 17, wherein the output of the second content is controlled based on interest information for the first content obtained from information of the user terminal that has acquired the first content information.

### (Supplementary Note 21)

The information providing method described in Supplementary note 20, wherein a delivery position or a delivery time of the second content is changed based on interest information for the first content obtained from the user terminal that has acquired the first content information.

### (Supplementary Note 22)

The information providing method described in Supplementary note 20, wherein content information is changed to second content information having an attribute different from that of the first content information based on interest information for the first content obtained from the user terminal that has acquired the first content information.

### (Supplementary Note 23)

The information providing method described in any one of Supplementary notes 20 to 22, wherein the interest information is determined based on biometric information of a user obtained from the user terminal.

### (Supplementary Note 24)

The information providing method described in any one of Supplementary notes 20 to 23, wherein the interest information is determined based on posture information of a user obtained from the user terminal.

### (Supplementary Note 25)

A non-transitory computer readable medium storing a program for causing a computer to:
acquire position information associated with a position on a map, content information associated with the position information, and an attribute corresponding to the content information; and
output first content information to a user terminal based on position information acquired from the user terminal, and then output second content information associated with an attribute of the first content information to the user terminal.

### (Supplementary Note 26)

The non-transitory computer readable medium described in Supplementary note 25, wherein the first content information includes guide information and the second content includes advertisement information.

### (Supplementary Note 27)

The non-transitory computer readable medium described in Supplementary note 25, wherein the first content information is output to the user terminal based on the position information acquired from the user terminal, and then the second content information associated with the attribute of the first content information is output to the user terminal based on the position information acquired from the user terminal.

### (Supplementary Note 28)

The non-transitory computer readable medium described in Supplementary note 25, wherein the output of the second content is controlled based on interest information for the first content obtained from information of the user terminal that has acquired the first content information.

### (Supplementary Note 29)

The non-transitory computer readable medium described in Supplementary note 28, wherein a delivery position or a delivery time of the second content is changed based on interest information for the first content obtained from the user terminal that has acquired the first content information.

### (Supplementary Note 30)

The non-transitory computer readable medium described in Supplementary note 28, wherein content information is changed to second content information having an attribute different from that of the first content information based on interest information for the first content obtained from the user terminal that has acquired the first content information.

### (Supplementary Note 31)

The non-transitory computer readable medium described in any one of Supplementary notes 28 to 30, wherein the interest information is determined based on biometric information of a user obtained from the user terminal.

### (Supplementary Note 32)

The non-transitory computer readable medium described in any one of Supplementary notes 28 to 31, wherein the interest information is determined based on posture information of a user obtained from the user terminal.

### REFERENCE SIGNS LIST

1 INFORMATION PROVIDING SYSTEM
8 USER
10 SERVER
20 USER TERMINAL
30 NETWORK
101 CONTROL UNIT
102 STORAGE UNIT
103 ACQUISITION UNIT
210 HEARABLE DEVICE
220 WEARABLE DEVICE
230 SMARTPHONE
1011 POSITION INFORMATION ACQUISITION UNIT
1012 INTEREST INFORMATION ACQUISITION UNIT
1014 CONTENT PROVIDING UNIT
1015 ADVERTISEMENT PROVISION CONTROL UNIT
1016 ACOUSTIC LOCALIZATION PROCESSING UNIT
1021 MAP INFORMATION DATABASE
1022 REGISTERED POSITION INFORMATION DATABASE
1023 USER INFORMATION DATABASE
1024 GEOFENCE DATABASE
1025 CONTENT DATABASE
1026 ADVERTISEMENT DATABASE
2101 DIRECTION DETECTION UNIT
2102 POSITION INFORMATION ACQUISITION UNIT
2103 SPEAKER
2104 COMMUNICATION UNIT
2105 CONTROL UNIT
2105a INTEREST INFORMATION IDENTIFICATION UNIT
2106 STORAGE UNIT
2201 BIOMETRIC INFORMATION ACQUISITION UNIT
2202 SPEAKER
2203 DISPLAY
2204 COMMUNICATION UNIT
2205 CONTROL UNIT
2205a INTEREST INFORMATION IDENTIFICATION UNIT
2301 DIRECTION DETECTION UNIT
2302 POSITION INFORMATION ACQUISITION UNIT
2303 SPEAKER/MICROPHONE
2304 DISPLAY
2305 CAMERA
2306 COMMUNICATION UNIT
2307 CONTROL UNIT
2307a INTEREST INFORMATION IDENTIFICATION UNIT
2308 STORAGE UNIT

What is claimed is:

1. An information providing apparatus comprising:
a storage unit configured to store position information associated with a position on a map, content information associated with the position information, and an attribute corresponding to the content information; and
at least one memory storing instructions, and
at least one processor configured to execute the instructions to;
output first content information to a user terminal based on position information acquired from the user terminal, and then output second content information associated with an attribute of the first content information to the user terminal based on the position information acquired from the user terminal.

2. The information providing apparatus according to claim 1, wherein the first content information includes guide information and the second content information includes advertisement information.

3. (canceled)

4. The information providing apparatus according to claim 1, wherein the at least one processor configured to execute the instructions to control the output of the second content information based on interest information for the first content information obtained from information of the user terminal that has acquired the first content information.

5. The information providing apparatus according to claim 1, wherein the at least one processor configured to execute the instructions to change a delivery position or a delivery time of the second content information based on interest information for the first content information obtained from the user terminal that has acquired the first content information.

6. The information providing apparatus according to claim 1, wherein the at least one processor configured to execute the instructions to change content information to second content information having an attribute different from that of the first content information based on interest information for the first content information obtained from the user terminal that has acquired the first content information.

7. The information providing apparatus according to claim 4, wherein the interest information is determined based on biometric information of a user obtained from the user terminal.

8. The information providing apparatus according to claim 4, wherein the interest information is determined based on posture information of a user obtained from the user terminal.

9. An information providing system comprising a user terminal and an information providing apparatus, wherein
the information providing apparatus includes:
a storage unit configured to store position information associated with a position on a map, content information associated with the position information, and an attribute corresponding to the content information; and
at least one memory storing instructions, and
at least one processor configured to execute the instructions to;
output first content information to the user terminal based on position information acquired from the user terminal, and then output second content information associated with an attribute of the first content information to the user terminal based on the position information acquired from the user terminal.

10. The information providing system according to claim 9, wherein the first content information includes guide information and the second content information includes advertisement information.

11. (canceled)

12. The information providing system according to claim 9, wherein the at least one processor configured to execute the instructions to control the output of the second content information based on interest information for the first content information obtained from information of the user terminal that has acquired the first content information.

13. The information providing system according to claim 12, wherein the at least one processor configured to execute the instructions to change a delivery position or a delivery time of the second content information based on interest information for the first content information obtained from the user terminal that has acquired the first content information.

14. The information providing system according to claim 12, wherein the at least one processor configured to execute the instructions to change content information to second content information having an attribute different from that of the first content information based on interest information for the first content information obtained from the user terminal that has acquired the first content information.

15. The information providing system according to claim 12, wherein the user terminal comprises a wearable device, and the interest information is determined based on biometric information of a user obtained from the wearable device

16. The information providing system according to claim 12, wherein the user terminal comprises a hearable device, and the interest information is determined based on posture information of a user obtained from the hearable device

17. An information providing method comprising:
acquiring position information associated with a position on a map, content information associated with the position information, and an attribute corresponding to the content information; and
outputting first content information to a user terminal based on position information acquired from the user terminal, and then outputting second content information associated with an attribute of the first content information to the user terminal based on the position information acquired from the user terminal.

18. The information providing method according to claim 17, wherein the first content information includes guide information and the second content information includes advertisement information.

19. (canceled)

20. The information providing method according to claim 17, wherein the output of the second content information is controlled based on interest information for the first content information obtained from information of the user terminal that has acquired the first content information.

21. The information providing method according to claim 20, wherein a delivery position or a delivery time of the second content information is changed based on interest information for the first content information obtained from the user terminal that has acquired the first content information.

22. The information providing method according to claim 20, wherein content information is changed to second content information having an attribute different from that of the first content information based on interest information for the first content information obtained from the user terminal that has acquired the first content information.

23. The information providing method according to claim 20, wherein the interest information is determined based on biometric information of a user obtained from the user terminal.

24-32. (canceled)
